(19) United States
(12) Patent Application Publication
(10) Pub. No.: US 2007/0208600 A1
(43) Pub. Date: Sep. 6, 2007

(54) Method and apparatus for pre-emptive operational risk management and risk discovery

(76) Inventors: Steven A. Babus, New Rochelle, NY (US); Wanli Min, Mount Kisco, NY (US); Bala Ramachandran, Harrison, NY (US); Jonathan Rosenoer, Saint Helena, CA (US)

Correspondence Address: Whitham, Curtis, & Christofferson, P.C., Suite 340, 11491 Sunset Hills Road, Reston, VA, 20190, US

(21) Appl. No.: 11/364,158

(22) Filed: Mar. 1, 2006

(51) Int. Cl. G06F 9/44

(52) U.S. Cl. 705/7

(57) ABSTRACT

A computer implemented method and a computer system implementing the method provide enterprises with pre-emptive/proactive operational risk management. First, historical data on the occurrence of operational risk events and other internal business/external metrics and indicators are collected. This is followed by construction of a model for correlating the risk events with internal and external metrics and indicators. This can result in the estimation of the probability of occurrence of risk events and a model for the severity of a loss event (in termns of, say, dollar amount) as a function of the various variables that are related to or have leverage on the business operation. The Key Risk Indicators for the business are then identified based on the model. Following this, the identified key risk factors are forecasted for future time periods and used to identify early warnings of risk and is further validated. This is used as a basis for the identification and execution of appropriate proactive/pre-emptive risk management and mitigation actions.

### CROSS-REFERENCE TO RELATED APPLICATION

This application is related in subject matter to copending U.S. patent application Ser. No. 10/983,641 filed Nov. 9, 2004, by Feng Cheng, David Gamarnik, Wanli Win, Bala Ramachandran, and Jonathan Miles Collin Rosenoer for “Method and Apparatus for Operational Risk Assessment and Mitigation” and assigned to a common assignee herewith. The disclosure of application Ser. No. 10/983,641 is incorporated herein by reference.

### BACKGROUND OF THE INVENTION

1. Field of the Invention

The present invention generally relates to modeling operational risk for pre-emptive risk management and risk discovery in business management and, more particularly, to an approach for identifying, predicting and assessing operational risks in order to take proactive steps to manage risks.

2. Background Description

Organizations are increasingly interested in robust systems for assessing and managing operational risk. The growing interest in operational risk management has been driven by a variety of factors, including the introduction of new regulations requiring businesses to quantify and manage operational risk, such as the New Basel Capital Accord, known as Basel II (see “The New Basel Capital Accord”, Bank for International Settlements, April 2003).

A prevailing definition of operational risk is given by the Basel Committee on Banking Supervision as “the risk of loss resulting from inadequate or failed internal processes, people or systems or from external events”. (See, “Working Paper on the Treatment of Operational Risk”, Basel Committee on Banking Supervision, September 2001.)

Prior art in operational risk modeling has been based on (a) operational risk assessment methods for quantifying operational risk using statistical modeling of rare events and extreme value theory (see for example, see Advances in Operational Risk, Risk Books, 2003), and (b) Bayesian networks (see, for example, Operational Risk—Measurement and Modeling, Jack King, Wiley Publishers, 2001). Even though these approaches are able to quantify risks at the enterprise level, they do not give a clear view of the Key Risk Indicators (KRI) and specific actions that can be taken to manage operational risks. Hence they are not suitable for predicting risk and proactively managing risk on an ongoing basis. Recent industry efforts are underway to define key risk indicators for operational risk management and the KRI Exchange (www.kriex.com) has defined more than 1800 risk indicators. In order to progress towards proactive risk management, an understanding has to be gained regarding the relationships between the risk indicators and loss events that can be used as a basis to score operational risks and predict risks based on the Key Risk Indicators. Predictive modeling has been used to score risks in the fraud management, credit risk space (www.fairisaac.com), but not for predicting general operational risks and proactively managing them.

The background described above indicates the need to develop a systematic methodology for pre-emptive operational risk assessment and risk discovery, leading to a functional operational risk assessment and management system. Such a methodology can further be used as a basis to identify and deploy different countermeasures for operational risk control and mitigation. The methodology consists of five steps: (1) Identify the risk factors from many candidate variables that are typically provided by experts familiar with operational processes in the business area under consideration. (2) Model the relationship between operational loss events and risk factors. (3) Identify Key Risk Indicators that serve to predict the potential for loss events (4) Construct forecasting models for the key risk factors and assess future risk exposures by the constructed model in step (2). (5) Monitor the Key Risk Indicators using the models to provide an early warning for risk events and proactively manage loss events.

### SUMMARY OF THE INVENTION

The present invention provides a system and method for pre-emptive operational risk assessment and risk discovery based on analysis of enterprise information on an ongoing basis. Information can be obtained in real-time or near real-time from runtime systems and from other enterprise information stores. According to one aspect of the invention, the method comprises the steps of:
Identifying data for risk analysis;
Obtaining information on operational risk events and other enterprise data;
Developing and calibrating models for assessing and discovering operational risks; and
Predicting future operational risks based on model.

The present invention differs from the prior art in the following respects:
We develop a system and method to identify key risk factors.
We use statistical techniques to model the relationship between risk events and key risk factors by providing a quantified measure of risk level.
We perform pre-emptive risk prediction by forecasting the key risk factors.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a a block diagram showing the overall system and method employed in the invention;

FIG. 2 is a block diagram showing the types of information that can be leveraged in the system and method;

FIG. 3 is a diagram illustrating the data of operational risk events and related business metrics described in the detailed example;

FIG. 4 is a schematic diagram showing the predicted risk level by the system and method adopted in the invention;

FIG. 5 shows an example severity distribution for operational loss events;

FIG. 6 is a schematic diagram showing how this system and method can be combined with other components to form a risk early warning system;

FIG. 7 is a block diagram of a computer system on which the system and method according to the invention may be implemented;

FIG. 8 is a block diagram of a server used in the computer system shown in FIG. 7; and

FIG. 9 is a block diagram of a client used in the computer system shown in FIG. 7.

### DETAILED DESCRIPTION OF A PREFERRED EMBODIMENT OF THE INVENTION

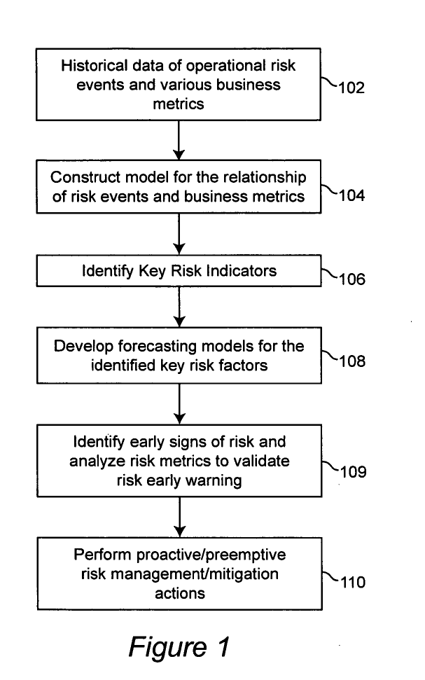

Referring now to the drawings, and more particularly to FIG. 1, there is shown a preferred embodiment of the system and method and data structures according to the present invention. Function block 102 involves collecting historical data on the occurrence of operational risk events and other internal business/external metrics and indicators during a selected time period. Function block 104 involves constructing a model for correlating the risk events with internal and external metrics and indicators. This can result in the estimation of the probability of occurrence of risk events and a model for the severity of loss event (in terms of, say, dollar amount) as function of the various variables that are related to or have leverage on the business operation. Function block 106 involves the selection of the Key Risk Indicators (KRI) using appropriate statistical techniques, based on the model constructed in 104. Function block 108 involves forecasting the identified key risk factors—the forecasting can include mathematical models such as time-series forecasting and in addition can include market intelligence and business judgment. Function block 109 involves forecasting future risk levels through the calibrated models and future forecast of key risk indicators, which is used to identify early signs of risk. Based on this, the risk metrics are further analyzed to validate and provide a risk early warning. Function block 110 involves the identification and execution of appropriate proactive/pre-emptive risk management and mitigation actions.

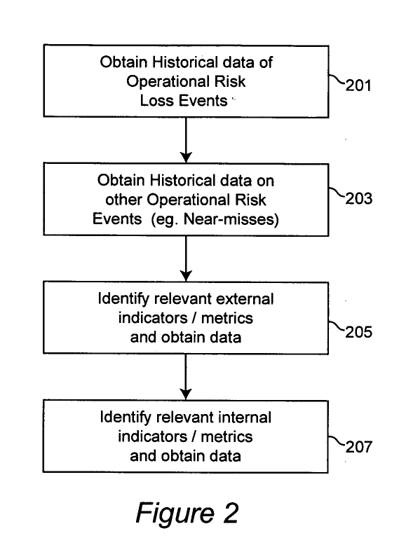

FIG. 2 provides further detail to the historical data that is referred to in block 102. Function block 201 involves the collection of historical data on operational loss events—i.e., operational risk events that resulted in significant financial losses. Function block 203 involves the collection of historical data on other operational risk events—for instance, near-miss risk events where financial impact was not incurred. Function block 205 involves the identification of relevant external indicators and metrics that are expected to have influence on the operational risks—these could include factors such as interest rates, S&P index etc. Function block 207 involves the identification of relevant internal business factors and risk indicators—for example, these could include factors such as profits, commission income, employee experience, etc.

The forecast involved in function block 108 consists of two aspects. First, forecasting the probability of future risk events; Second, forecast the severity (say, dollar amount) of future risk event should it happen. This essentially enables us to obtain an estimate of Value-at-Risk (VaR). For example, suppose we forecast the risk event would occur in the next time period with probability of 0.8, and the severity is over $1M with probability 99% should it happen, then the forecasted VaR during the next time period is over $1M with probability of 79.2% obtained through the definition of conditional probability: P(VaR>x)=P(Var>x|Risk event occurs) P(risk event occurs).

We describe here a specific embodiment of the invention for pre-emptive operational risk management and risk discovery using a simple example based on analyzing the risks in each desk for a trading scenario. The goal hiere is to identify Key Risk Indicators that can be employed in a proactive manner through ongoing monitoring to provide early warning/alerts to future risk events.

Our approach is as follows:
1. Identify internal metrics that can potentially impact loss events—these include metrics such as client revenue, profit, commission fee, human resources (HR) related metrics, etc.
2. Historical loss events are used along with the indicators to calibrate a predictive model for risk
3. The predictive model is self-calibrating and is updated on an ongoing basis based on ongoing observation of loss events

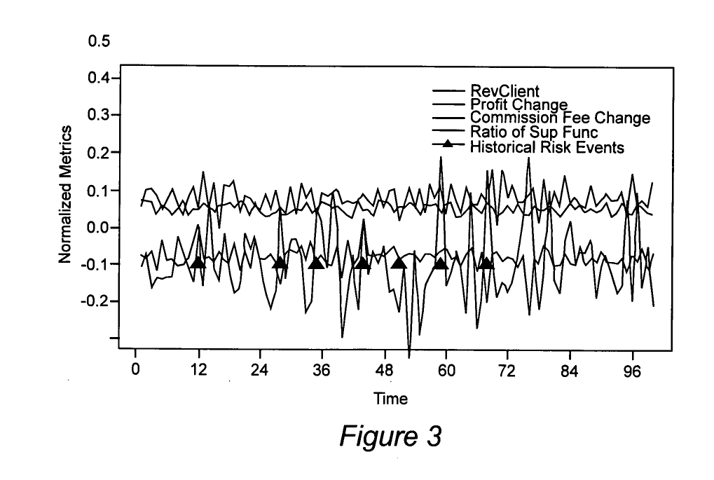

FIG. 3 shows some of the input data that is used to calibrate a predictive model for risk. FIG. 3 shows a combination of both historical data on metrics and future forecasts—in this instance, the current time period is 72. Hence all data points, before the current time refers to historical data, while data corresponding to future time periods refer to forecasts. We are going to use the data during the first 72 periods to construct model to correlate operational losses with risk indicators and identify Key Risk Indicators.

Many statistical techniques are readily applicable to modeling the operational risk, which corresponds to the function block 104 in FIG. 1. We present two possible approaches below:
Let Xₜ=(X_{1,t}, . . . , X_{p,t}) be the complete business metrics at time t, such as revenue, commission fee, etc. We model the probability of an operational risky event would occur by a logistic function.

$$log \frac{{P}_{t}}{1 - {P}_{t}} = {β}_{0} + {β}_{1} {X}_{1 , t} + … + {β}_{p} {X}_{p , t} \qquad ( 1 )$$

The variables X_{p,t} can either be continuous variables (e.g., commission fees) or categorical variables (e.g., Medium Customer Satisfaction). Having a record of operational risky events at each time point and the corresponding Xₜ, we perform a logistic regression to fit the model specified by Equation (1). The past metrics of Xₜ₋₁, . . . , Xₜ₋ₖ can be easily included in this model to assess influence of different risk factors after a time lag.

The issue of selecting key risk factors can be addressed by hypothesis testing. For instance, if we want to check whether X₁, X₂ are important factors in determining the probability of risky events, we may fit the model reduced from Equation (1) without X₁, X₂, i.e., with the constraint of β₁=0, β₂=0. We denote this reduced model as Model II and the complete model as Model I. We may test the significance of the reduction of log-likelihood from Model I to Model II by referring to classical generalized linear model theory (see, for example, Generalized Linear Models, P. McCullagh and J. A. Nelder, Chapman & Hall, 1989). We give a brief account of the procedure in the following. Let X₁, . . . , Xₙ, y₁, . . . ,yₙ be the observed data sample where Xₜ is the business metric as time t and yₜ is an indicator of risky event at time t, i.e., yₜ=1 if there is a risky event and 0 otherwise. The log-likelihood function of the logistic regression is

$$LL = {\sum }_{t = 1}^{n} [ {y}_{t} log ( P ( {X}_{t} ) ) + ( 1 - {y}_{t} ) log ( 1 - P ( {X}_{t} ) ) ]$$

where P(Xₜ) is specified by Equation (1). Models I and II have different log-likelihood since they have different model formula for P(Xₜ). The significance of reduction of log-likelihood can be tested by the test statistic D=2[LL(Model I)—LL(Model II)]. D is usually referred as deviance. Under the null hypothesis that Model I and Model II are equivalent, D follows approximately a chi-squared distribution with degree of freedom df=number of extra parameters in Model I. Large D indicates significant reduction in the log-likelihood, which further indicates the significance of the variables not included from the complete model, i.e., Model I. In the aforementioned example, suppose the deviance D between Model I and Model II is 12.45, the corresponding P-value is P(X₂²>12.45)=0.002, i.e., there is only 0.2% probability of observing a deviance D as high as 12.45 should Model II be equivalent to Model I, which is very unlikely. Therefore, we reject the null hypothesis, i.e., the variables X₁, X₂ are key risk indicators.

It is also capable of predicting the probability of risky events in future based on the calibrated model parameters and time series forecasting of the business metrics Xₜ. Pₜ can also be interpreted as a composite score for operational risk.
Instead of modeling the probability of risky events directly, we consider first a categorical variable Sₜ as an indicator of operational risk level, for instance, “Minimum Risk”, “Low Risk”, “Medium Risk”, and “High Risk”. Denote these states as 1-4. We model P(Sₜ=s) through a non-homogeneous hidden Markov model specified as follows:

$$\begin{matrix}P ( {S}_{t} = s \text{\vert} {S}_{t - 1} = v , {X}_{t - 1} , {Z}_{t} ) = \frac{exp ( {λ}_{sv} + {γ}_{s}^{′} {Z}_{t} + {q}_{s}^{t} {X}_{t - 1} )}{{\sum }_{ξ = 1}^{H} exp ( {λ}_{ξ v} + {λ}_{ξ}^{t} {Z}_{t} + {q}_{ξ}^{t} {Z}_{t - 1} )} & ( 2 ) \\ P ( {X}_{t} \text{\vert} {S}_{t} = s ) \sim f ( {Θ}_{s} ) & ( 3 )\end{matrix}$$

where Zₜ are exogenous variables which have leverage on the business processes, such as S&P500. Θₛ stands for the parameters of the distribution of metrics Xₜ given the risk level at s. Parameter estimates can be obtained by maximum likelihood estimate. Markov Chain Monte Carlo (MCMC) is another vehicle to make inference of the future risk levels.

Another approach of identifying a few factors that can be used to score operational risk does not require a specific model assumption like the one postulated in Equation (1). Let X₁, . . . , Xₙ be the normalized observed business metrics through time period 1, . . . , n where Xₜ=(X_{1,t}, . . . ,X_{p,t}) is a p-dimensional vector and each component corresponds to a risk indicator. The meaning of “normalized” is that each component of X is standardized by subtracting the mean and then dividing by the standard deviation. Since p is typically large, we may apply Principal Component Analysis (PCA) to identify s key risk indicators derived from the p components where s<<p. Principal Component Analysis (PCA) aims at reducing a large set of variables to a small set without losing much of the information in the large set (see, for example, Principal Component Analysis, Jolliffe I. T., New York: Springer, 1986). More specifically, we look for

$$PX = {\sum }_{i = 1}^{p} {w}_{i} {X}_{i} ,$$

a linear combination of X_{1,t}, . . . , X_{p,t}, which has the most variation, i.e.

$${max}_{{\sum }_{i = 1}^{p} {w}_{i}^{2} = 1} var ( {\sum }_{i = 1}^{p} {w}_{i} {X}_{i} ) .$$

The problem can be solved by solving the eigenvalue decomposition of the variance-covariance matrix of X, denoted by

$$Σ = \frac{1}{n} {\sum }_{t = 1}^{n} {X}_{t}^{T} {X}_{t} ,$$

where T stands for transpose of vector or matrix. Let λ₁≧λ₂≧ . . . ≧λₚ≧0 be the leading eigenvalues of Σ and W₁, . . . , Wₚ be the corresponding eigenvectors, then the first s principal components are Wᵢ^{T}X,i=1, . . . , s. If the percentage of variation that explained by these s components,

$${\sum }_{i = 1}^{s} {λ}_{i} / {\sum }_{i = 1}^{p} {λ}_{i} ,$$

is sufficiently high (above 95%, say), then most information carried in the original p factors are well retained by the s components. Therefore, we may model the probability of risk events as a function of these s principal components, W₁^{T}X, . . . , Wₛ^{T}X, where s<<p. Often it is the case that a key risk indicator is one or several nonlinear functions of the observed Xₜ. In this scenario, traditional PCA cannot reduce the dimensionality effectively. A nonlinear version of PCA can be performed. It is a linear PCA in a reproducing kernel Hilbert Space H. (See, for example, Learning with Kernels, B. Scholkopf and A. J. Smola, MIT Press, Cambridge, Mass., 2002). Define a mapping Φ from space of X to H such that for any X,X′ ε X, the inner product in space is defined as <Φ(X),Φ(X′)>=K(X,X′), where K(,) is a kernel function that measures similarity between X,X′. A typical choice of K(,) is polynomial kernel function K(x,x′)=(x^{T}x^{t})^{d}. Let λ₁≧λ₂ . . . and W₁, W₂, . . . be the eigenvalues and eigenvectors of the Gram matrix K=(K(Xᵢ,Xⱼ))_{1≦i,j≦n}, then the kth leading principal component in space H can be written as

$$\frac{1}{{λ}_{k}} {\sum }_{i = 1}^{n} {W}_{k , i} K ( {X}_{i} , X ) .$$

So rather than using all p components of X, we may just use the first s several leading principal components,

$$\frac{1}{{λ}_{k}} {\sum }_{i = 1}^{n} {W}_{k , i} K ( {X}_{i} , X ) , k = 1 , … , s ,$$

as our key risk factors provided that

$${\sum }_{k = 1}^{s} {λ}_{k} / {\sum }_{k = 1}^{n} {λ}_{k}$$

is large enough (say, above 95%). In practice, the number of leading components to retain can be adjusted iteratively until satisfactory prediction power is achieved.

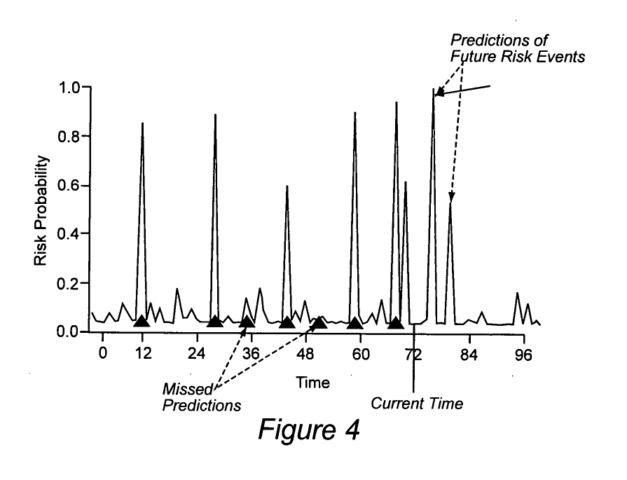

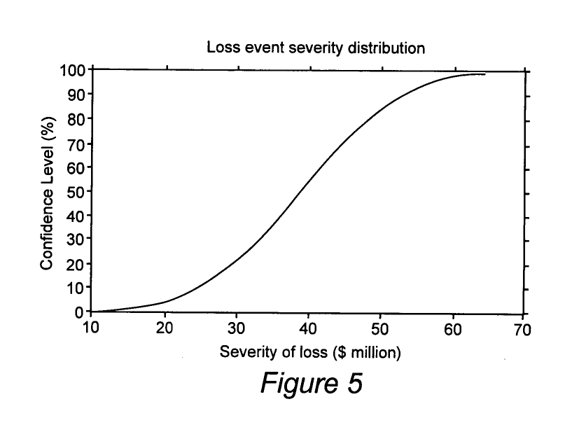

This model can then be used as a basis to perform risk prediction for future time periods. FIG. 4 plots the estimated probability of risk events at various past time periods, where the red triangles on the horizontal axis indicate real risk events. This indicates that the underlying model reasonably captures the underlying factors that correlate with the operational risk events. FIG. 4 also shows the future predictions for operational risk events. FIG. 5 shows the severity distribution for operational loss events.

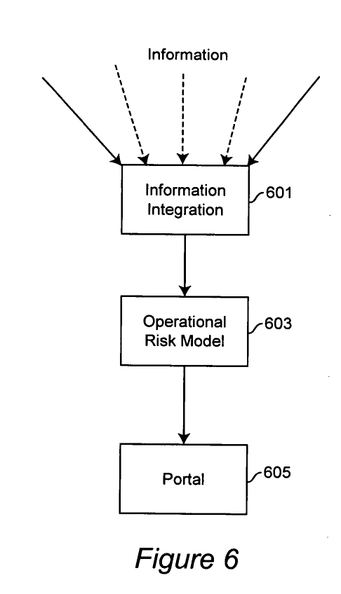

FIG. 6 illustrates how the methodology described herein can be combined with other system components to provide the means for early warning for operational risks. Component 601 is an information integration component that integrates information from different sources, including real-time information. Component 603 represents the operational risk model described in this disclosure. Component 605 is a portal component that displays risk related information, including early warnings of operational risk events.

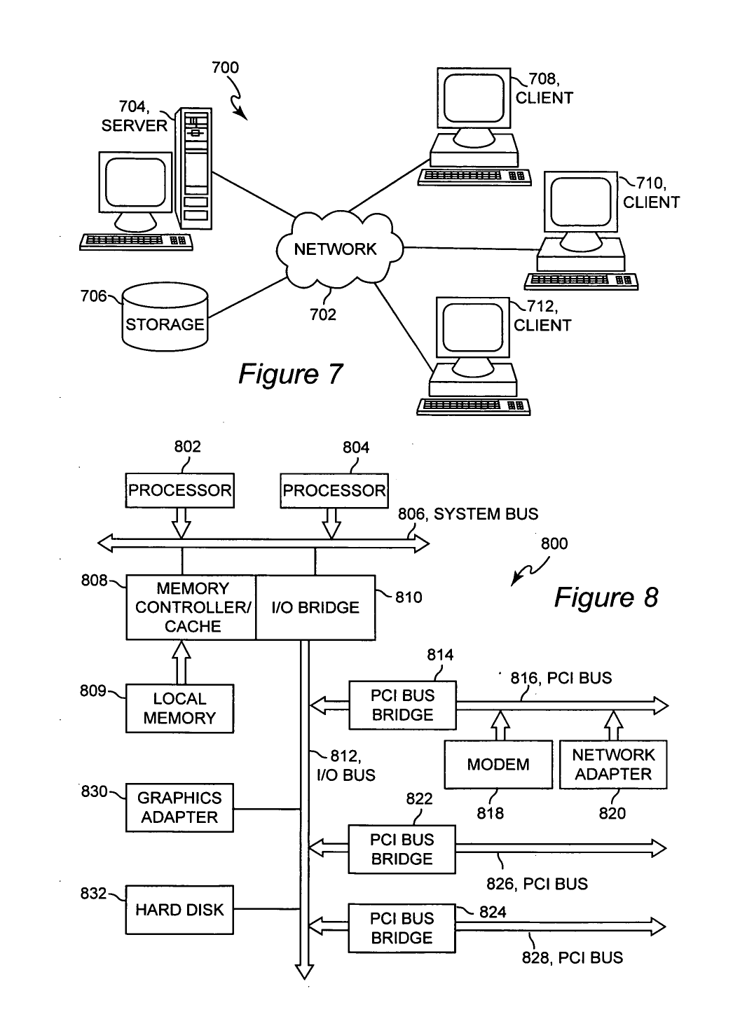

FIG. 7 shows a computer system on which the method according to the invention may be implemented. Computer system 700 contains a network 702, which is the medium used to provide communications links between various devices and computers connected together within computer system 700. Network 702 may include permanent connections, such as wire or fiber optic cables, wireless connections, such as wireless Local Area Network (WLAN) products based on the IEEE 802.11 specification (also known as Wi-Fi), and/or temporary connections made through telephone, cable or satellite connections, and may include a Wide Area Network (WAN) and/or a global network, such as the Internet. A server 704 is connected to network 702 along with storage unit 706. In addition, clients 708, 710 and 712 also are connected to network 702. These clients 708, 710 and 712 may be, for example, personal computers or network computers. For purposes of this application, a network computer is any computer, coupled to a network, which receives a program or other application from another computer coupled to the network. The server 704 provides data, such as boot files, operating system images, and applications to clients 708, 710 and 712. Clients 708, 710 and 712 are clients to server 704.

Computer system 700 may include additional servers, clients, and other devices not shown. In the depicted example, the Internet provides the network 702 connection to a worldwide collection of networks and gateways that use the TCP/IP (Transmission Control Protocol/Internet Protocol) suite of protocols to communicate with one another. At the heart of the Internet is a backbone of high-speed data communication lines between major nodes or host computers, consisting of thousands of commercial, government, educational and other computer systems that route data and messages. In this type of network, hypertext mark-up language (HTML) documents and applets are used to exchange information and facilitate commercial transactions. Hypertext Transfer Protocol (HTTP) is the protocol used in these examples to send data between different data processing systems. Of course, computer system 700 also may be implemented as a number of different types of networks such as, for example, an intranet, a local area network (LAN), or a wide area network (WAN). FIG. 7 is intended as an example, and not as an architectural limitation for the present invention.

Referring to FIG. 8, a block diagram of a data processing system that may be implemented as a server, such as server 704 in FIG. 1, is depicted in accordance with a preferred embodiment of the present invention. Server 800 may be used to execute any of a variety of business processes. Server 800 may be a symmetric multiprocessor (SMP) system including a plurality of processors 802 and 804 connected to system bus 806. Alternatively, a single processor system may be employed. Also connected to system bus 806 is memory controller/cache 808, which provides an interface to local memory 809. Input/Output (I/O) bus bridge 810 is connected to system bus 806 and provides an interface to I/O bus 812. Memory controller/cache 808 and I/O bus bridge 810 may be integrated as depicted.

Peripheral component interconnect (PCI) bus bridge 814 connected to I/O bus 812 provides an interface to PCI local bus 816. A number of modems may be connected to PCI bus 816. Typical PCI bus implementations will support four PCI expansion slots or add-in connectors. Communications links to network computers 808, 810 and 812 in FIG. 1 may be provided through modem 818 and network adapter 820 connected to PCI local bus 816 through add-in boards.

Additional PCI bus bridges 822 and 824 provide interfaces for additional PCI buses 826 and 828, from which additional modems or network adapters may be supported. In this manner, server 800 allows connections to multiple network computers. A graphics adapter 830 and hard disk 832 may also be connected to I/O bus 812 as depicted, either directly or indirectly.

Those of ordinary skill in the art will appreciate that the hardware depicted in FIG. 8 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 8 may be, for example, an IBM RISC/System 6000 system, a product of International Business Machines Corporation of Armonk, N.Y., running the Advanced Interactive Executive (AIX) operating system.

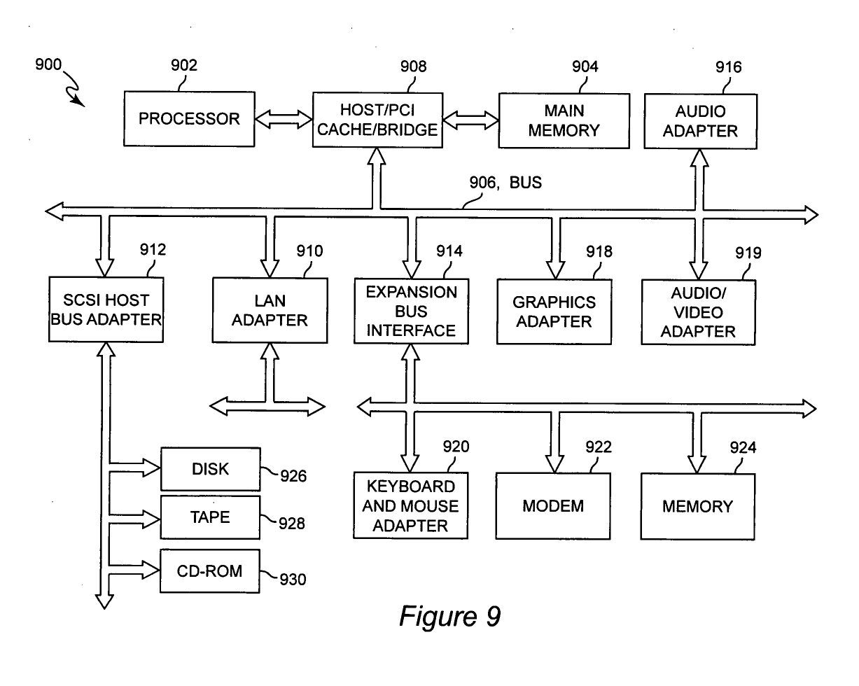

With reference now to FIG. 9, a block diagram illustrating a client computer is depicted in accordance with a preferred embodiment of the present invention. Client computer 900 employs a Peripheral Component Interconnect (PCI) local bus architecture. Although the depicted example employs a PCI bus, other bus architectures such as Accelerated Graphics Port (AGP) and Industry Standard Architecture (ISA) may be used. Processor 902 and main memory 904 are connected to PCI local bus 906 through PCI bridge 908. PCI bridge 908 also may include an integrated memory controller and cache memory for processor 902. Additional connections to PCI local bus 906 may be made through direct component interconnection or through add-in boards.

In the depicted example, local area network (LAN) adapter 910, Small Computer System Interface (SCSI) host bus adapter 912, and expansion bus interface 914 are connected to PCI local bus 906 by direct component connection. In contrast, audio adapter 916, graphics adapter 918, and audio/video adapter 919 are connected to PCI local bus 906 by add-in boards inserted into expansion slots. Expansion bus interface 914 provides a connection for a keyboard and mouse adapter 920, modem 922, and additional memory 924. SCSI host bus adapter 912 provides a connection for hard disk drive 926, tape drive 928, and CD-ROM drive 930. Typical PCI local bus implementations will support three or four PCI expansion slots or add-in connectors.

An operating system runs on processor 902 and is used to coordinate and provide control of various components within data processing system 900 in FIG. 9. The operating system may be a commercially available operating system, such as Windows XP, which is available from Microsoft Corporation. An object-oriented programming system such as Java may run in conjunction with the operating system and provides calls to the operating system from Java programs or applications executing on data processing system 900. “Java” is a trademark of Sun Microsystems, Inc. Instructions for the operating system, the object-oriented operating system, and applications or programs are located on storage devices, such as hard disk drive 926, and may be loaded into main memory 904 for execution by processor 902.

Those of ordinary skill in the art will appreciate that the hardware in FIG. 9 may vary depending on the implementation. Other internal hardware or peripheral devices, such as flash ROM (or equivalent nonvolatile memory) or optical disk drives and the like, and/or I/O devices, such as Universal Serial Bus (USB) and IEEE 1394 devices, may be used in addition to or in place of the hardware depicted in FIG. 9. Also, the processes of the present invention may be applied to a multiprocessor data processing system.

Data processing system 900 may take various forms, such as a stand alone computer or a networked computer. The depicted example in FIG. 9 and above-described examples are not meant to imply architectural limitations.

Note that the scope of this disclosure is not limited by the specific computational methods described in this document. The methodology and apparatus described herein can be combined with other computational methods for operational risk. Moreover, this disclosure is not limited by any specific system components described in this document. A pre-emptive operational risk management solution can be realized by combining the methodology described herein with other system components. Further, the scope of this disclosure is not limited by specific risk indicators or business metrics described in this document. The invention described here is applicable to any selected set of risk indicators, business metrics.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for pre-emptive operational risk management and risk disclovery comprising the steps of:
identifying data for risk analysis;
obtaining information on operational risk events and other enterprise data;
developing and calibrating a model for assessing and discovering operational risks; and
predicting future operational risks based on model.

2. The method according to claim 1, further comprising the steps of:
identifying Key Risk Indicators (KRI) from the model; and
monitoring the KRI in the process of business operation.

3. The method according to claim 2, wherein in the step of predicting includes the steps of:
identifying early signs of risk;
analyzing risk metrics to validate risk early warning; and
forecasting future risk probability.

4. The method according to claim 1, further comprising the step of performing proactive/pre-emptive risk management/mitigation action based on the risk early warning.

5. The method according to claim 1, wherein the model is used to estimate the Value-at-Risk (VaR) in future time periods.

6. The method according to claim 1, wherein the model is re-calibrated on a real-time basis by adding newly arrived data to the step of developing and calibrating the model.

7. The method according to clam 6, wherein the re-calibration of the model is performed automatically.

8. The method according to claim 1, wherein data for model development is gathered and maintained using an information integration solution.

9. The method according to claim 3, wherein the early risk warning is communicated using portals or other electronic media.

10. The method according to claim 1, further comprising the steps of:
identifying one or more external indicators that could be related to operational risk and obataining historical data; and
developing a model to relate risk events with internal and external metrics.

11. The method according to claim 1, further comprising the steps of:
obtaining historical data on risk events that did not incur financial losses, but were near-misses; and
developing a model to relate the risk events with internal and external metrics.

12. A computer system implementing a method for pre-emptive management of operational risk of a business enterprise comprising:
input means for identifying one or more business metrics/indicators that could be related to operational risk and obtaining historical data;
processing means for developing a model to relate risk events with business metrics, identifying Key Risk Indicators (KRI) from the model, monitoring the KRI in a process of business operation and forecasting future risk probability, identifying early signs of risk and analyzing risk metrics to validate risk early warning; and
output means for peforming proactive/pre-emptive risk management/mitigation action based on the risk early warning.

13. A computer readable media implementing a method of pre-emptive management of operational risk of a business enterprise comprising the steps of:
identifying one or more business metrics/indicators that could be related to operational risk;
obtaining historical data on operational loss events;
developing a model to relate risk events with business metrics;
identifying Key Risk Indicators (KRI) from the model;
monitoring KRI in a process of business operation and forecasting future risk probability;
identifying early signs of risk and analyzing risk metrics to validate risk early warning; and
performing proactive/pre-emptive risk management/mitigation action based on the risk early warning.
